(19) United States
(12) Patent Application Publication
(10) Pub. No.: US 2016/0317998 A1
(43) Pub. Date: Nov. 3, 2016

(54) METHOD OF PREPARING AN ADSORBENT MATERIAL SHAPED IN THE ABSENCE OF BINDER AND METHOD OF EXTRACTING LITHIUM FROM SALINE SOLUTIONS USING SAID MATERIAL

(71) Applicants: ERAMET, Paris (FR); IFP ENERGIES NOUVELLES, Rueil-malmaison (FR)

(72) Inventors: Malika BOUALLEG, VILLEURBANNE (FR); Olivier LAFON, LYON (FR); Fabien André Pierre BURDET, PLAISIR (FR); Romain Charles Joseph René SOULAIROL, PARIS (FR)

(73) Assignees: ERAMET, Paris (FR); IFP ENERGIES NOUVELLES, Rueil-malmaison (FR)

(21) Appl. No.: 15/107,453

(22) PCT Filed: Dec. 23, 2014
(86) PCT No.: PCT/EP2014/079118

§ 371 Date: Jun. 22, 2016

(30) Foreign Application Priority Data
Dec. 23, 2013 (FR) 1363465

(51) Int. Cl. B01J 20/08; C02F 1/28; C01D 15/04; B01D 15/36; B01J 20/04; B01J 20/30

(52) U.S. Cl. CPC B01J 20/08; B01J 20/046; B01J 20/3007; B01J 20/3078; C01D 15/04; B01D 15/36; C02F 1/281

(57) ABSTRACT

A method for preparing a crystallized solid material of formula LiCl.2Al(OH)₃,nH₂O with n being comprised between 0.01 and 10, includes mixing in an aqueous medium, at least one source of alumina and at least one source of lithium in order to obtain a suspension, filtering the resulting suspension obtained for obtaining a slurry, followed by drying the obtained slurry at a temperature between 20 and 80° C. for a period between 1 h and 12 h, then shaping by extrusion the resulting dried slurry, directly after the drying to obtain extrudates, where the shaping was carried out without any binder, and then the drying of the obtained extrudates at a temperature comprised between 20 and 200° C. for a period between 1 hour and 20 hours, in order to obtain the crystallized solid material of formula LiCl.2Al(OH)₃,nH₂O as extrudates. A method for extracting lithium from saline solutions uses the thereby prepared material.

### TECHNICAL FIELD

The present invention relates to the field of solid materials for adsorption of lithium. In particular, the present invention relates to a novel method for preparing a crystallized solid material and as an extrudate, of formula LiCl.2Al(OH)₃,nH₂O with n being comprised between 0.01 and 10, said shaping step by extrusion being carried out in the absence of any binder, and to a method for extracting lithium from salt solutions using said crystallized solid material of formula LiCl.2Al(OH)₃,nH₂O with n being comprised between 0.01 and 10 prepared according to the novel preparation method according to the invention. The present invention relates to a shaped crystallized solid material of formula LiCl.2Al(OH)₃,nH₂O with n being comprised between 0.01 and 10. The present invention relates to a device applying the method for extracting lithium.

### PRIOR ART

Lithium ions coexist with massive amounts of metals such as for example alkaline, earth-alkaline metals, boron and metal sulfates, in particular in salt solutions such as brines. Thus, they have to be the subject of an economical and selective extraction from these salt solutions. Indeed, the chemical properties of lithium and of alkaline metals, preferably sodium (Na), and potassium (K) and earth-alkaline metals, preferably magnesium (Mg), calcium (Ca) and strontium (Sr), make separation of these elements difficult.

Solid materials of formula LiCl.2Al(OH)₃,nH₂O with n being comprised between 0.01 and 10 are known for their use in adsorption/desorption phenomena of lithium ions and in particular in the methods for extracting lithium from salt solutions. These not very stable structures would allow insertion of lithium atoms into the structure and thus extraction of the lithium.

Several operating procedures leading to solids which may adsorb selectively lithium have been shown in the prior art. In all the cases, a solid, aluminium tri-hydroxide Al(OH)₃, either prepared or commercially purchased, is put into contact with a lithium precursor. Three main precursors are used: the most used is lithium chloride (LiCl). A lithium hydroxide (LiOH) or a lithium carbonate (Li₂CO₃) may also be applied.

U.S. Pat. No. 6,280,693 describes a method for preparing a solid LiCl/Al(OH)₃ by addition of an aqueous solution of LiOH to a polycrystalline hydrated alumina in order to form LiOH/Al(OH)₃, and thus generate active lithium sites in the crystalline layers of the alumina without altering the structure thereof. The transformation of LiOH/Al(OH)₃ into LiCl/Al(OH)₃ is then achieved by adding diluted hydrochloric acid. The thereby prepared alumina pellets are then used in a method for extracting lithium from brines at a high temperature. The method for extracting lithium described in U.S. Pat. No. 6,280,693 uses the solid detailed above and comprises the steps hereafter:
a) saturating a solid bed with a brine containing a lithium salt LiX, X being selected from halides, nitrates, sulfates and bicarbonates,
b) displacing the brine impregnated with a concentrated NaX solution,
c) eluting the LiX salt captured by the solid by the passage of an unsaturated LiX solution,
d) displacing the impregnating agent with a concentrated NaX solution, steps a) to d) are then repeated at least once.

Patent RU 2 234 367 describes a method for preparing a solid of formula LiCl.2Al(OH)₃,nH₂O comprising a step for mixing aluminium trichloride (AlCl₃) and lithium carbonate (Li₂CO₃) in the presence of water at 40° C. The obtained residue is filtered and washed and then dried for 4 hours at 60° C. The thereby obtained solid is not shaped.

The obtained solid is used for extracting the lithium contained in saline solutions by putting it into contact with water in order to remove a portion of the lithium and then by putting it into contact with a saline solution containing lithium. The thereby obtained static capacity is comprised between 6.0 and 8.0 mg of lithium per g of solid.

Patent CN1243112 describes a method for preparing a solid of formula LiCl.2Al(OH)₃,nH₂O comprising a step for precipitating aluminium hydroxide Al(OH)₃ microcrystals by putting it into contact with AlCl₃ and sodium hydroxide NaOH, and then putting said microcrystals into contact with a 6% solution of lithium chloride LiCl at 80° C. for 2 hours followed by filtration, by rinsing and by drying in order to obtain a powder of LiCl.2Al(OH)₃,nH₂O provided with a non-ordered and amorphous structure. A solution of macromolecular polymer selected from fluorinated resins, polyvinyl chloride (PVC), chlorinated polyvinyl chloride (CPVC), ethylene perchlorate and cellulose acetate-butyrates (CAB) acting as a binder is then mixed with the powder of LiCl.2Al(OH)₃,nH₂O in order to obtain a slurry which is then shaped by granulation followed by drying in air.

The use of such a solid in a method for extracting lithium from brines from salted lakes gives the possibility of obtaining a low Mg/Li ratio and a mother-liquor rich in lithium and compliant with the production standards of lithium carbonates or chlorides.

A goal of the present invention is to provide a solid material allowing selective extraction of lithium from brine, said solid material being of good quality, and having good cohesion, without any apparent defects.

A goal of the present invention is to provide a novel method for preparing such a solid material.

Another goal of the present invention is to provide a method for extracting lithium from saline solutions using said solid material.

### SUMMARY AND ADVANTAGE OF THE INVENTION

The applicants discovered a novel method for preparing a crystallized solid material of formula LiCl.2Al(OH)₃,nH₂O with n being comprised between 0.01 and 10, and in particular that the fact of carrying out the step for shaping by extrusion of a slurry, in the absence of any binder, directly, after a drying step operating under specific conditions, the shaping step then being followed by a final drying step also operating under specific conditions, gave the possibility of obtaining a crystallized solid material of formula LiCl.2Al(OH)₃,nH₂O as extrudates of good quality, having good cohesion, without any apparent defects. The applicants thus discovered a novel crystallized solid material of formula LiCl.2Al(OH)₃,nH₂O with n being comprised between 0.01 and 10, shaped, having good quality for the goals sought.

By <<material of formula LiCl.2Al(OH)₃.nH₂O>> is preferably meant a material essentially comprising or consisting of a crystallized phase of formula LiCl.2Al(OH)₃,nH₂O.

The object of the present invention is a method for preparing a crystallized solid material of formula LiCl.2Al(OH)₃,nH₂O with n being comprised between 0.01 and 10, said method comprising at least the following steps:
a) a step for mixing, in an aqueous medium, at least one alumina source and at least one lithium source in order to obtain a suspension,
b) a step for filtering the suspension obtained in step a) for obtaining a slurry,
c) a step for drying the slurry obtained at the end of step b), at a temperature comprised between 20 and 80° C. for a period comprised between 1 h and 12 h,
d) a step for shaping by extrusion said dried slurry, directly after the drying step c) in order to obtain extrudates, said shaping step d) being carried out in the absence of any binder,
e) a step for drying the extrudates obtained at the end of step d) at a temperature comprised between 20 and 200° C. for a period comprised between 1 and 20 hours, in order to obtain the crystallized solid material of formula LiCl.2Al(OH)₃,nH₂O as extrudates.

In the whole of the following of the text, by binder is meant any organic or inorganic compound which may be added in the shaping step d), or any precursors of organic or inorganic compounds which may form an organic or inorganic binder in situ, under the conditions of the shaping step d) by extrusion.

An advantage of the preparation method according to the invention is to give the possibility of obtaining a shaped crystallized solid material and advantageously as extrudates of formula LiCl.2Al(OH)₃,nH₂O with n being comprised between 0.01 and 10, of good quality, without any apparent defects, and having good cohesion.

An object of the present invention is therefore also a crystallized solid material of formula LiCl.2Al(OH)₃,nH₂O with n being comprised between 0.01 and 10, set into shape. This shaped solid material may be obtained according to the method of the invention. By <<shaping>>, is meant that the material is solid and has sufficient cohesion when the solid is put into contact with a brine solution so that it does not substantially lose its physical integrity, i.e. it substantially retains its shape. More specifically, a shaped solid in the sense of the invention covers a solid retaining its cohesion under conditions for extracting lithium defined in the examples. In particular, the terms of <<shaped>> cover a material obtained by granulation, (called a granule), and preferably by extrusion (called an extrudate).

Another advantage of the preparation method according to the invention is to give the possibility of obtaining a shaped crystallized solid material and advantageously as extrudates, of formula LiCl.2Al(OH)₃,nH₂O with n being comprised between 0.01 and 10, having no or few cracks which may cause swelling which is detrimental to cohesion and to the strength of the material when the latter is put into contact with a brine solution.

An object of the present invention is also a method for extracting lithium from saline solutions, using a crystallized solid material shape, and advantageously as extrudates of formula LiCl.2Al(OH)₃,nH₂O with n being comprised between 0.01 and 10, prepared according to a novel preparation method according to the invention.

An advantage of the extraction method according to the invention is to allow selective extraction of lithium from a saline solution and thereby obtaining a high decontamination factor as compared with the initial saline solution, calculated as being the X/Li ratio which is equal to the molar ratio of X/Li concentrations in the initial saline solution divided by the molar ratio of X/Li concentrations in the final solution, X being selected from sodium (Na), potassium (K), magnesium (Mg), calcium (Ca), boron (B), sulfur (S) and strontium (Sr).

The object of the present invention is also a device for extracting lithium from saline solution(s). The device according to the invention thus applies the extraction method according to the invention.

### DESCRIPTION OF THE INVENTION

According to the invention, at least one source of alumina and at least one source of lithium are mixed in an aqueous medium in order to obtain a suspension in step a).

Preferably, the alumina source is aluminium tri-hydroxide Al(OH)₃.

Aluminium tri-hydroxide Al(OH)₃ may advantageously be a commercial compound.

Preferably, aluminium tri-hydroxide Al(OH)₃ is prepared by precipitating aluminium trichloride (AlCl₃) and soda (NaOH).

In this case, said alumina source and preferably the aluminium tri-hydroxide Al(OH)₃ is prepared prior to the mixing with at least one lithium source. Aluminium trichloride AlCl₃ and soda NaOH are advantageously mixed in the presence of water in order to form a precipitate which is advantageously filtered and washed at least once. The obtained precipitate is then mixed according to step a) with at least one lithium source in order to obtain a suspension.

The lithium source(s) may be any compound comprising the element lithium and which may release this element in an aqueous solution in a reactive form. Preferably, the lithium source(s) is (are) selected from lithium salts and preferably from lithium chloride (LiCl), lithium hydroxide (LiOH), lithium nitrate, (LiNO₃), lithium sulfate (Li₂SO₄) and lithium carbonate (Li₂CO₃), taken alone or as a mixture.

Most preferably, the lithium source is lithium chloride (LiCl).

Preferably, at least one alumina source and at least one lithium source are mixed in the presence of water for obtaining a suspension in step a). Preferably, said mixing step a) operates under intensive stirring.

Preferably, said mixing step a) operates at a temperature comprised between 40 and 120° C. and preferably between 60 and 100° C., for a period comprised between 1 hour and 10 hours, preferably between 1 and 8 hours, preferably between 1 and 6 hours and more preferably between 1 and 3 hours.

According to the invention, the suspension obtained at the end of step a) undergoes a filtration step b) in order to obtain a slurry.

Preferably, the filtration is carried out on a Buchner filter, with displacement of water.

According to the invention, the slurry obtained at the end of step b) is dried in a drying step c) at a temperature comprised between 20 and 80° C., for a period comprised between 1 h and 12 h.

Preferably, said drying preferably operates in an oven, at a temperature comprised between 20 and 60° C. and most preferably between 30 and 50° C., for a period comprised between 1 h and 10 h.

The operating conditions of said drying step c) give the possibility of obtaining a dried slurry having a loss on ignition (LOI) comprised between 45 and 75% and preferably between 50 and 70%. The obtained loss on ignition allows extrusion of the dried slurry under good conditions and the obtaining of resistant and defect-free extrudates, i.e. without any cracks.

In order to determine the LOI after the shaping step, a portion of the obtained slurry is sampled and put into an oven for 6 h at 120° C. The LOI is obtained by the difference between the mass of the sample before and after ovening.

According to the invention, said dried slurry obtained at the end of the drying step c) undergoes, directly after the drying step c), a step d) for shaping by extrusion in order to obtain extrudates, said shaping step being carried out in the absence of any binder.

Preferably, said dried slurry does not undergo any intermediate steps between said drying step c) and said shaping step d) by extrusion, preferably no kneading step and more preferably no acid/basic kneading step.

Thus, more preferably, said shaping step d) is carried out without adding any acid or base to the dried slurry introduced in said step d).

Preferably, said shaping step d) is carried out in the absence of binders selected from among inorganic binders, such as for examples hydraulic binders or inorganic binders which may be generated under the conditions of said step d) by addition of precursors of inorganic binders, and organic binders such as for example paraffins or polymers.

Advantageously, the solid material according to the invention does not comprise any binder, notably selected from among inorganic binders and organic binders.

The shaping step d) by extrusion is advantageously carried out in a known way to one skilled in the art.

In particular, the dried slurry from the drying step c) advantageously passes through a die, for example by means of a piston or a twin-screw or single-screw continuous extruder. The diameter of the die of the extruder is advantageously variable and is comprised between 0.1 and 5 mm, preferably between 0.2 and 3 mm and preferably between 0.3 and 2 mm. The shape of the die, and therefore the shape of the material obtained as an extrudate, is advantageously cylindrical, and may for example be with a circular, annular, trilobed, quadri-lobed or else multilobed sections. The shaped solid material according to the invention may thus have such characteristics. Notably, the shaped solid material has a section or diameter substantially equivalent to that of the die of the extruder, and advantageously comprised between 0.1 and 5 mm, preferably between 0.2 and 3 mm and preferably between 0.3 and 2 mm. Thus the shaped material according to the present invention may be wire-shaped with a length for example comprised between 1 and 10 cm, or further for example between 2 and 6 cm. The shape may be hollow (tubular) or solid.

According to the invention, the extrudates obtained at the end of step d) undergo a drying step e) at a temperature comprised between 20 and 200° C. for a period comprised between 1 hour and 20 hours, in order to obtain the crystallized solid material of formula LiCl.2Al(OH)₃,nH₂O as extrudates.

Preferably, said drying step e) operates at a temperature comprised between 20 and 100° C., preferably between 20 and 80° C. and more preferably between 20 and 60° C., for a period comprised between 1 and 18 hours, preferably between 5 and 14 hours and preferably between 8 and 14 hours.

The specific conditions of said drying step e) give the possibility of obtaining a crystallized solid material having the desired phase LiCl.2Al(OH)₃,nH₂O.

Said drying step e) is advantageously carried out according to techniques known to one skilled in the art and preferably in an oven.

The method according to present invention therefore gives the possibility of obtaining a crystallized solid material of formula LiCl.2Al(OH)₃,nH₂O with n being comprised between 0.01 and 10, preferably between 0.1 and 5 and preferably between 0.1 and 1, as extrudates with a section or diameter comprised between 0.2 and 5 mm, preferably between 0.3 and 4 mm, preferably between 0.3 and 3 mm, most preferably between 0.3 and 2 mm and even most preferably between 0.3 and 1.8 mm.

The best results in terms of mechanical strength and cohesion of the crystallized solid material obtained according to the preparation method according to the invention are obtained in the case of extrudates with a section or diameter comprised between 0.2 and 5 mm and preferably comprised between 0.3 and 1.8 mm, said extrudates having been obtained by means of a combination of a quite specific shaping step as described above and a final drying step e) carried out at a temperature comprised between 20 and 60° C. and in particular at 40° C., for a period comprised between 5 and 14 hours, preferably between 8 and 14 hours and in particular for 8 hours.

The crystallized solid material of formula LiCl.2Al(OH)₃,nH₂O as extrudates, prepared according to the sequence of steps a), b), c) and d) of the preparation method according to the invention may be characterized according to the following techniques: nitrogen adsorption for determining the specific surface area according to the BET method; X-ray diffractometry in the diffraction angle range of 20=0.8 to 40°±0.02° in a reflection geometry in order to identify the structure of said material and for elementary analysis.

The crystallized solid material of formula LiCl.2Al(OH)₃,nH₂O advantageously shaped as extrudates, advantageously has a specific surface area measured according to the BET method comprised between 1 and 30 m²/g and preferably between 1 and 20 m²/g.

The X-ray diffraction diagram of the shaped crystallized solid material of formula LiCl.2Al(OH)₃,nH₂O with n being comprised between 0.01 and 1, preferably between 0.1 and 0.5 and preferably between 0.1 and 0.4, obtained according to the invention, advantageously as extrudates, is characteristic of a non-amorphous material and has at least the following lines:

| 2θ | d (Å) |
|---|---|
| 11.505 | 7.69 |
| 20.195 | 4.39 |
| 23.065 | 3.85 |
| 35.937 | 2.50 |
| 39.948 | 2.26 |
| 55.406 | 1.66 |
| 63.243 | 1.47 |
| 64.349 | 1.45 |

The preparation method according to the present invention therefore gives the possibility of obtaining a crystallized solid material of formula LiCl.2Al(OH)₃,nH₂O shaped, advantageously as extrudates, having both a low specific BET surface area, good cohesion and not having any apparent defects.

The goods properties of the obtained material result from the combined effect of shaping, advantageously by extrusion of a slurry, in the absence of any binder, directly, after a drying step preferably operating under specific conditions, and upon applying a final drying step following the shaping, preferably also operating under specific conditions.

Thus, the object of the present invention is a crystallized solid material of formula LiCl.2Al(OH)₃,nH₂O with n being comprised between 0.01 and 1, preferably between 0.1 and 0.5 and preferably between 0.1 and 0.4, shaped, preferably as a granule, and further preferably as an extrudate. In particular, the extruded solid material may be obtained according to the preparation method of the invention.

The object of the present invention is also a method for extracting lithium from a saline solution using said crystallized solid material of formula LiCl.2Al(OH)₃,nH₂O with n being comprised between 0.01 and 10, according to the invention.

Said saline solution used in the extraction method according to the invention advantageously comprises a lithium concentration comprised between 0.001 mol/L and 0.5 mol/L, preferably between 0.02 mol/L and 0.3 mol/L.

Said saline solution also contains other species, such as for example the species selected from the following list: Na, K, Rb, Cs, Mg, Ca, Sr, Ba, F, Cl, Br, I, SO₄, CO₃, NO₃, and HCO₃. Said saline solution may advantageously be saturated with salts or not.

Said saline solution may be any natural saline solution, concentrated or stemming from a method for extracting or transforming lithium. For example, said saline solution used in the extraction method according to the invention may advantageously be selected from brines of salted lakes or from geothermal sources, brines subject to evaporation for obtaining brines concentrated in lithium, sea water, effluents of factories producing cathodes, or for producing lithium chloride or hydroxide and the effluents of method for extracting lithium from minerals.

The method for extracting lithium according to the invention is preferably a selective extraction method of lithium. Indeed, it allows separation of lithium from alkaline metals, preferably sodium (Na), and potassium (K) and earth-alkaline metals for example magnesium (Mg), calcium (Ca) and strontium (Sr), present in a massive amount in the saline solutions treated in said extraction method.

The extraction method of lithium according to the invention also allows selective separation of the lithium from other compounds such as boron and sulfates.

The method for extracting lithium according to the invention is advantageously applied in a unit comprising at least one column, said column(s) comprising at least one bed of said crystallized solid material of formula LiCl.2Al(OH)₃,nH₂O with n being comprised between 0.01 and 1, shaped and prepared according to the preparation method according to the invention.

Preferably, said method for extracting lithium according to the invention is applied in a unit comprising between one and four columns, and preferably between two and three columns.

Said method for extracting lithium advantageously comprises at least the following steps:
a step for activating said crystallized solid material of formula LiCl.2Al(OH)₃,nH₂O with n being comprised between 0.01 and 10,
a step for loading said activated material by adsorption achieved by passing said saline solution over said activated material,
at least one step for washing the saline solution impregnating said material by passing a washing solution over said material,
a step for desorption of lithium carried out by having water or an aqueous solution of a lithium salt pass over said material in order to obtain an eluate comprising at least some lithium.

Preferably, said step for activating the crystallized solid material of formula LiCl.2Al(OH)₃,nH₂O with n being comprised between 0.01 and 10, as extrudates, is carried out in a single go upon putting the synthesized material in a column and shaping it according to the preparation method according to the invention.

Said activation step may activate the sites intended to selectively adsorb lithium.

Preferably, said activation step is advantageously carried out by having water or a lithium salt solution with a concentration comprised between 0.001 mol/L and 0.1 mol/L, preferably between 0.001 mol/L and 0.05 mol/L and preferably between 0.01 and 0.04 mol/L pass upwards or downwards, and preferably downwards.

Preferably, the lithium salt used in a solution in said activation step is selected from lithium chloride (LiCl), lithium nitrate and lithium bromide.

Most preferably, the lithium salt used in solution in said activation step is lithium chloride (LiCl).

According to a preferred embodiment, said activated crystallized solid material undergoes at the end of the activation step a step for washing with a lithium chloride (LiCl) solution

Said activation step is advantageously carried out at a temperature comprised between 0° C. and 90° C., and preferably between 10° C. and 60° C., and preferably between 10° C. and 30° C. at a flow rate comprised between 0.1 BV/h and 30 BV/h, and preferably between 1 BV/h and 15 BV/h.

The amount of solution required for activation is advantageously comprised between 1 BV and 30 BV, preferably between 2 BV and 20 BV.

By BV is meant the volume occupied by the bed of the solid in the column.

Said step for loading said activated material by adsorption is advantageously carried out by the upward or downward, and preferably upward passing of the saline solution treated in the extraction method according to the invention, over said activated material.

Said loading step is advantageously carried out at a temperature comprised between 0° C. and 90° C., and preferably between 10° C. and 70° C. at a flow rate comprised between 0.1 BV/h and 30 BV/h, and preferably between 1 BV/h and 15 BV/h.

The amount of solution required for saturating said material depends on the adsorption capacity of said material and on the lithium concentration of the saline solution.

The adsorption capacity of said material is comprised between 1 and 50, preferably between 1 and 30 and preferably between 1 and 10 mg of Li/g of dry solid material.

In the case when said method for extracting lithium according to the invention is applied in a unit comprising two columns, the first column is advantageously saturated with lithium during said loading step. The second column receiving the outflow of the first column is advantageously loaded until a lithium leak is obtained not exceeding 10% of the lithium concentration of the inflow and preferably 5%, thereby allowing maximization of the lithium recovery yield.

In the case when said method for extracting lithium according to the invention is applied in a unit comprising three columns, the third column, already saturated with lithium, is dedicated to the washing and then desorption steps of the lithium, described hereafter, during the loading of the other two columns.

The present invention covers a device comprising such units. The device according to the invention may comprise one or several units according to the invention.

The first fraction of the outflow of said loading step by adsorption, advantageously between 0 BV and 1 BV, corresponds to the removal of the impregnating agent from the activation step of the solid material. This fraction may be considered as an effluent or recycled agent, and preferably recycled as an inflow of the desorption step. In the case of the treatment of natural brine or sea water, beyond 1 BV, the entirety of the outflow of said loading step by adsorption, called hereafter a raffinate which has not undergone any chemical treatment, is advantageously and preferably sent back to the original saline solution deposit.

At the end of the loading step by having the saline solution treated in the method according to the invention pass over the activated material, the saline solution impregnates said activated material.

The saline solution impregnating the activated material is then washed in at least one washing step by having a washing solution pass over said material.

Said washing step(s) for the saline solution impregnating said material, is (are) advantageously carried out by having a washing solution pass upwards or downwards over said material, and preferably downwards.

Preferably, said washing solution is selected from water and an aqueous solution of a sodium salt and preferably of sodium chloride (NaCl), optionally comprising a lithium salt and preferably lithium chloride (LiCl), said solution advantageously having a concentration of sodium salt and preferably of sodium chloride (NaCl), greater than 2 mol/L, preferably comprised between 2 mol/L and the saturation and a concentration of lithium salt and preferably of lithium chloride (LiCl), comprised between 0 mol/L and 2 mol/L.

According to a preferred embodiment, said saline solution impregnating the activated material undergoes a final washing step by having an aqueous washing solution of sodium chloride (NaCl) optionally comprising lithium chloride (LiCl), pass over said material.

Said washing step is advantageously carried out at a temperature comprised between 0° C. and 90° C., and preferably between 10° C. and 70° C., and at a flow rate comprised between 0.1 BV/h and 30 BV/h, and preferably between 1 BV/h and 15 BV/h. The amount of solution required for washing is comprised between 0.1 BV and 10 BV, typically in the range from 0.5 BV to 5 BV.

The outflow of said washing step is considered as an effluent or is advantageously recycled, and preferably recycled to the inlet of the loading step or directly at the inlet of the second column in the case when said method for extracting lithium according to the invention is applied in a unit comprising at least two columns.

The device according to the present invention may advantageously comprise a unit for recycling the outflow of the washing unit.

Said washing step gives the possibility of washing the impregnated saline solution in said material during the step for loading said material by adsorption, while limiting desorption of the lithium.

In the case when said washing solution is an aqueous solution saturated with sodium chloride (NaCl), said washing step not only gives the possibility of removing the impregnated saline solution in said material during the step for loading said material by adsorption but also of desorbing the elements such as boron, sulfates, alkaline metals other than lithium and earth-alkaline metals.

The desorption step of lithium is then carried out by having water or an aqueous solution of lithium chloride (LiCl) pass over said material at the end of the washing step in order to obtain an eluate comprising at least some lithium.

Preferably, said desorption step is carried out by having water or a lithium chloride (LiCl) solution pass downwards or upwards and preferably downwards, containing 0.001 mol/L to 2 mol/L of LiCl, and preferably from 0.01 mol/L to 1 mol/L.

Said desorption step is advantageously carried out at a temperature comprised between 0° C. and 90° C., and preferably between 10° C. and 70° C. at a flow rate comprised between 0.1 BV/h and 30 BV/h, and preferably between 1 BV/h and 15 BV/h.

The amount of lithium chloride (LiCl) solution required for desorption is advantageously comprised between 0.01 and 10 BV, and preferably between 0.05 BV and 5 BV.

The outflow of said desorption step of the lithium generates the final product of the method, called an eluate.

The eluate is advantageously recovered between 0 BV and 4 BV, and preferably between 0.2 BV and 3 BV.

The whole of the other fractions of the outflow from this step not making up the final product called eluate, is considered as an effluent or is advantageously recycled, and preferably recycled at the inlet of the washing step or of the loading step.

The eluate obtained at the end of the extraction method according to the invention is a solution in majority containing the elements Li, Na and Cl as well as impurities preferably selected from among K, Mg, Ca, Sr, B or SO₄.

The eluate is then advantageously concentrated and then purified in order to obtain a lithium salt of high purity.

Said method for extracting lithium according to the invention allows selective extraction of lithium from a saline solution and thus gives the possibility of obtaining a high decontamination factor with respect to the initial saline solution, calculated as being the X/Li ratio which is equal to the molar ratio of the X/Li concentration in the initial saline solution divided by the molar ratio of the X/Li concentration in the eluate, X being selected from sodium (Na), potassium (K), magnesium (Mg), calcium (Ca), boron (B), sulfur (S) and strontium (Sr).

The present invention also covers a device for extracting lithium characterizing that it comprises a unit comprising at least one column, said column comprising at least one packing comprising the crystallized solid material of formula LiCl.2Al(OH)₃,nH₂O with n being comprised between 0.01 and 1, preferably between 0.1 and 0.5 and preferably between 0.1 and 0.4, shaped, as defined according to the present invention.

More particularly, the invention covers a device applying the method for extracting lithium according to the invention. Still more specifically, the device of the present invention comprises units or means applying the different steps of the method for extracting lithium according to the invention.

The terms <<according to the invention>> or equivalent terms, are intended to cover any embodiment, alternative, advantageous or preferred feature, taken alone or according to any of their combinations, without any limitation.

### DESCRIPTION OF THE FIGURES

FIG. 1 illustrates a photograph of the solid material of formula LiCl.2Al(OH)₃,nH₂O obtained as extrudates according to comparative Example 2.

FIG. 2 illustrates the X-ray diffraction diagram of the solid material of formula LiCl.2Al(OH)₃,nH₂O obtained as extrudates according to the comparative Example 3.

FIG. 3 illustrates a photograph of the solid material of formula LiCl.2Al(OH)₃,nH₂O obtained as extrudates according to Example 4 according to the invention.

FIG. 4 illustrates the X-ray diffraction diagram of the solid material of formula LiCl.2Al(OH)₃,nH₂O obtained as extrudates according to Example 4 according to the invention.

The invention is illustrated by the following examples which by no means have any limiting nature.

### EXAMPLES

### Example 1

### Comparative

A solid material of formula LiCl.2Al(OH)₃,nH₂O with n being comprised between 0.01 and 1 is prepared according to a synthesis method non-compliant with the invention in that the step for shaping the obtained slurry is carried out according to the conventional acid kneading/basic extrusion technique, a technique applied according to the knowledge of one skilled in the art.

### 1/ Synthesis of Al(OH)₃

In a beaker cooled by an ice bath, a solution containing 326 ml of permuted water and 135.6 g of aluminium chloride hexahydrate (AlCl₃) is prepared. Next, under magnetic stirring, 67.5 g of sodium hydroxide (NaOH) are slowly added. This cake is suspended in a 3 L beaker with 320 mL of water.

### 2/ Addition of Lithium Chloride LiCl

A solution is prepared, containing 78.5 g of lithium chloride LiCl provided by Prolabo and 1,326 ml of water which is added to the re-pulped cake. This reaction medium is stirred and heated to 80° C. for 2 h.

Filtration and then drying in an oven at 80° C. for 8 h follow the first 2 steps.

The obtained dried slurry is then shaped according to the conventional acid/basic kneading/extrusion technique. The dried slurry is introduced in a kneader of the Brabender type. The water acidified with nitric acid is added within 4 minutes, with kneading at 20 rpm. The acid kneading is continued for 10 minutes. A neutralization step is then carried out by adding an ammonia solution into the kneader and kneading is continued for 3 minutes.

The kneading is carried out with a total acid level, expressed with respect to the 2% dried slurry, and a neutralization level of 20%.

At the end of the kneading, no cohesive slurry was able to be obtained.

The obtained wet solid is shaped by means of a piston extruder (MTS), equipped with a cylindrical die with a diameter of 1 mm.

No intact extrudate was able to be obtained.

The obtained rings are very friable and have no hold in the brine.

### Example 2

### Comparative

A solid material of formula LiCl.2Al(OH)₃,nH₂O with n being comprised between 0.01 and 1 is prepared according to a synthesis method not compliant with the invention in that the step for shaping the obtained slurry is carried out by kneading—extrusion in the presence of an inorganic binder from the family of hydraulic binders added during the kneading phase.

37.7 g of solid material of formula LiCl.2Al(OH)₃,nH₂O with n being comprised between 0.01 and 1 is obtained according to the method described in Example 1 with the slight difference that the shaping step is carried out by kneading—extrusion in the presence of an inorganic binder.

The obtained dried slurry at the end of the first drying of Example 1 is introduced into a kneader of the Brabender type in the presence of 21.8 g of water and in the presence of 4.6 g of Dyckerhoff cement as a hydraulic binder and is simply kneaded.

The obtained slurry is shaped by means of a piston extruder (MTS), equipped with a cylindrical die with a diameter of 1 mm.

The extrudates obtained at the end of the shaping step are then dried in an oven at 40° C. for 12 h.

The extrudates obtained at the end of the shaping step were also dried in a weathering oven at 25° C. for 48 h under air saturated with 98% of water.

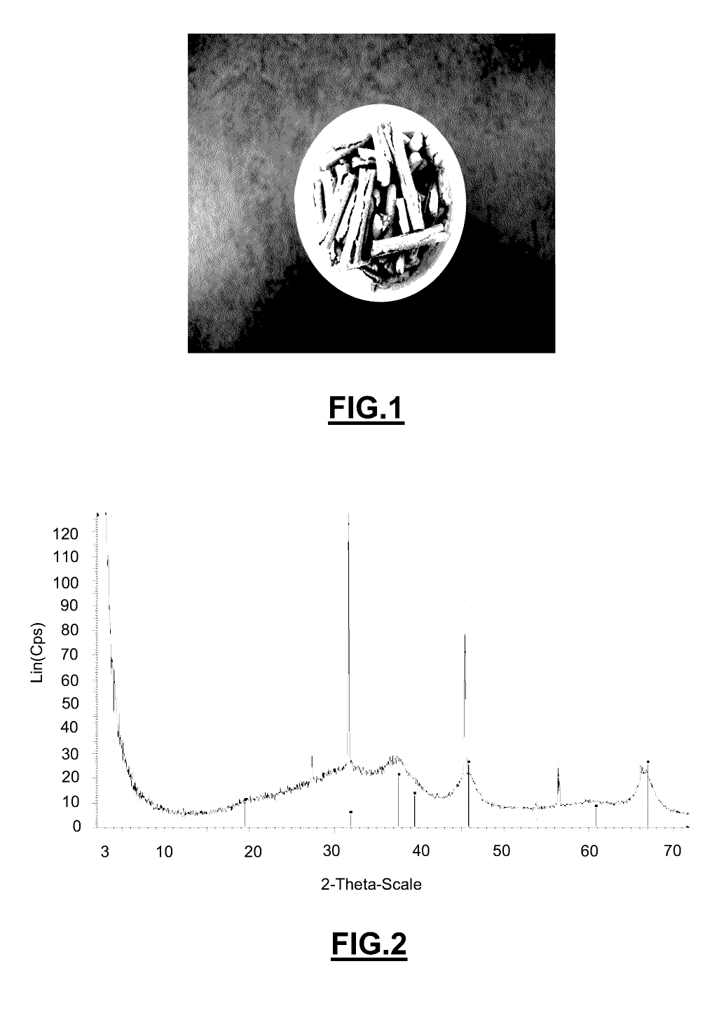

Both drying methods led to the same results: the obtained extrudates are illustrated in FIG. 1, they are friable and have many cracks.

### Example 3

### Comparative

A solid material of formula LiCl.2Al(OH)₃,nH₂O with n being comprised between 0.01 and 1 is prepared according to a synthesis method not compliant with the invention in that the step for calcination of the extrudates is carried out according to the knowledge of one skilled in the art at a temperature above 500° C.

### 1/ Synthesis of Al(OH)₃

In a beaker cooled by an ice bath, a solution containing 326 ml of permuted water and 135.6 g of aluminium chloride hexahydrate AlCl₃ is prepared. Next, under magnetic stirring, 67.5 g of sodium hydroxide NaOH are slowly added. The cake is suspended in a 3 L beaker with 320 mL of water.

### 2/ Addition of Lithium Chloride LiCl

A solution containing 78.5 g of lithium chloride LiCl provided by Prolabo and 1,326 ml of water is prepared, which is added to the re-pulped cake. This reaction medium is stirred and heated to 80° C. for 2 h.

Filtration and then drying in an oven at 40° C. for 8 h follow the first 2 steps.

The obtained slurry is directly shaped by means of a piston extruder (MTS), equipped with a cylindrical die with a diameter of 0.8 mm, without any kneading step beforehand. Extrudates having a proper aspect are obtained. These extrudates are calcined at 500° C. for 4 h.

The X-ray diffraction diagram of the extrudates of the solid material of formula LiCl.2Al(OH)₃,nH₂O obtained in FIG. 2 exhibits an undesired phase of the Li_{0.5}Al₂O₄ type which is a product from the decomposition of the phase LiCl.2Al(OH)₃,nH₂O.

### Example 4

### Invention

A solid material of formula LiCl.2Al(OH)₃,nH₂O with n=0.25 according to a synthesis method compliant with the invention is prepared, in that the step for shaping the obtained slurry is directly carried out after the drying step, without any kneading step beforehand.

### 1/ Synthesis of Al(OH)₃

In a beaker cooled by an ice bath, a solution containing 326 ml of permuted water and 135.6 g of aluminium chloride hexahydrate (AlCl₃) is prepared. Next under magnetic stirring, 67.5 g of sodium hydroxide (NaOH) are slowly added. This cake is suspended in a 3 L beaker with 320 mL of water.

### 2/ Addition of Lithium Chloride LiCl

A solution is prepared, containing 78.5 g of lithium chloride LiCl provided by Prolabo and 1,326 ml of water which is added to the re-pulped cake. This reaction medium is stirred and heated to 80° C. for 2 h.

Filtration and then drying in an oven at 40° C. for 8 h follow the first 2 steps.

The obtained slurry is directly shaped by means of a piston extruder (MTS), without any intermediate kneading step of said slurry. The piston extruder is equipped with a cylindrical die with a diameter of 0.8 mm. These extrudates are then dried at 40° C. for 12 h in an oven.

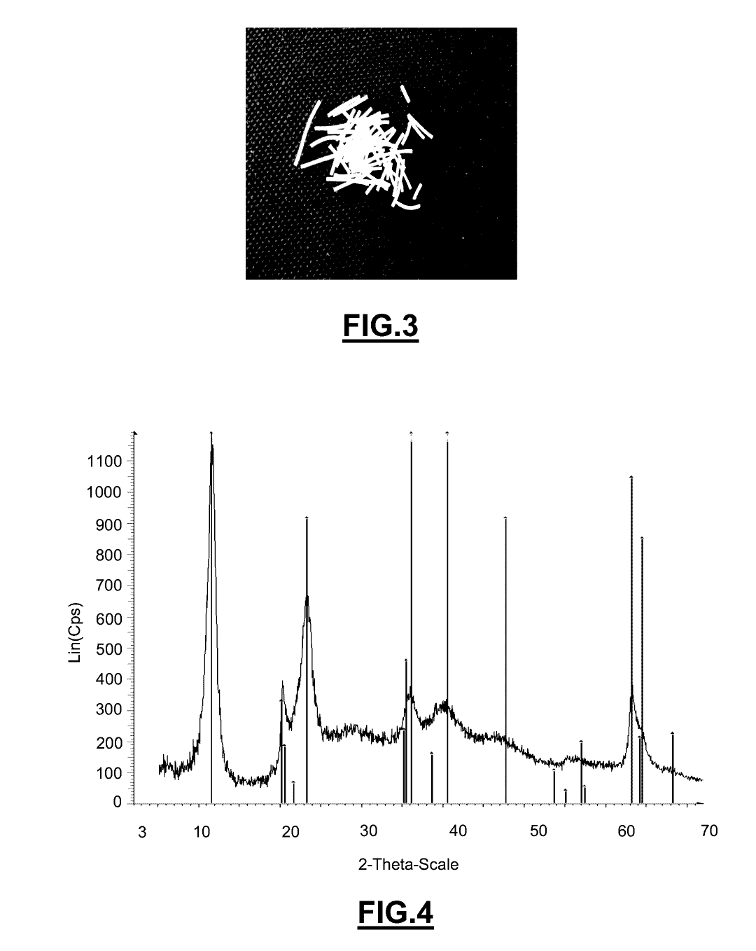

Extrudates of the solid material of formula LiCl.2Al(OH)₃,nH₂O with n=0.25 having good cohesion and a proper aspect are obtained. The obtained extrudates are illustrated on the photograph of FIG. 3.

A phase LiCl.2Al(OH)₃,nH₂O is detected on the X-ray diffraction diagram of the extrudates of the solid material of formula LiCl.2Al(OH)₃,nH₂O with n=0.25 of FIG. 4.

The obtained extrudates are also characterized by the following measurements: Elementary analysis shows good Li/Al/Cl stoichiometry corresponding to the composition of a structure LiCl.2Al(OH)₃,nH₂O

Al=21.2% by mass; Li=4.2% by mass; Cl=19% by mass.

The obtained extrudates have a specific surface area: S_{BET}=3 m²/g.

### Example 5

### Cohesion Test

The mechanical strength of the extrudates obtained according to Examples 1, 2 and 3 are tested in contact with a brine solution.

The different results are summarized in Table 1.

TABLE 1
Applied shaping procedure and aspect of the corresponding extrudates

| | | Examples | | |
|---|---|---|---|---|
| | 1 (not | | | 4 (according to the |
| | compliant) | 2 (not compliant) | 3 (not compliant) | invention) |
| Shaping step | Acid and basic | Kneading with a | direct extrusion | direct extrusion |
| | kneading + | cement binder + | | |
| | extrusion | extrusion | | |
| | without any | | | |
| | binder | | | |
| Die | 1 mm | 1 mm | 0.8 mm | 0.8 mm |
| Final drying | — | Weathering oven, | 500° C., 4 h | 40° C., 12 h |
| of the | | 25° C., 98% of | | |
| extrudates | | water or 40° C., | | |
| (step e) | | 12 h | | |
| Aspect of the | [symbol] rings [symbol] which | many cracks, | Die of 0.8 mm: | Die 0.8 mm: |
| extrudates in | rapidly | extrudates which | 40° C.: extrudates | 40° C.: extrudates |
| contact with | disintegrate | become powder | without any | without any apparent |
| brine | | | apparent defects | defects |
| XRD phase | — | — | Li_{0.5}Al₂O₄ | LiCl.2Al(OH)₃, nH₂O |

The extrudates obtained according to the invention (Example 4) comparatively with those obtained according to preparation methods not compliant with the invention, have good cohesion, have no or few cracks which may cause swelling detrimental to the cohesion and to the strength of the material when the latter is put in contact with a brine solution. Moreover, said extrudates according to the invention remain intact and produce very little fines when they are placed in a brine solution.

### Example 6

### Mechanical Strength Resistance Test by Accelerated Ageing on a Stirring Table

The mechanical strength of the extrudates may be tested via an accelerated ageing procedure on a stirring table:

5 g of shaped solid material and 25 ml of natural brine are placed in a cylindrical container with a capacity of 60 ml. This container is attached to the stirring table during the whole duration of the test.

The composition of the natural brine used during this test is given in Table 2.

TABLE 2
composition of the natural brine used for the mechanical strength test

| | Na | K | Li | Mg | Ca | B | SO₄ | Sr | Cl |
|---|---|---|---|---|---|---|---|---|---|
| Concen- | 4.4 | 0.24 | 0.068 | 0.086 | 0.040 | 0.031 | 0.035 | 0.001 | 4.89 |
| tration | | | | | | | | | |
| (mol/L) | | | | | | | | | |

The stirring table is driven with a horizontal unidirectional movement of an amplitude of 4 cm at a speed of 190 movements per minute. The shaped solids are thus stirred for a total period of 168 h.

At the end of these 168 h, the shaped solids-brine mixture is sieved by means of a 315 μm grid. Next, the shaped solids remaining on the sieve are washed with brine, the composition of which is indicated in Table 2. The thereby obtained liquid fraction, containing fine solid particles (with a diameter of less than 315 μm) in suspension, is filtered by means of a Buchner equipped with a paper filter, the pores of which have a dimension of 0.45 μm. The cake formed by the agglomeration of the fine particles is washed with demineralized water.

The thereby obtained solid residue is dried in an oven at 50° C. until stabilization of the mass.

The ratio of the solid residue mass over the initial shaped solid mass is then calculated, giving access to a destruction percentage of the shaped solids.

The destruction percentage of the shaped solids gives the possibility of appreciating the cohesion of the solids. Good cohesion is notably obtained for solids, for which the destruction percentage is less than 60%, and preferably less than 50%. The extrudates of Example 4 properly meet this condition. The extrudates obtained in Examples 1 and 2 have a destruction percentage of more than 60%.

### Example 7

### According to the Invention

test of the material according to the invention conducted according to Example 4 in the method for extracting lithium according to the invention.

The material according to the invention prepared in Example 4 is introduced into a jacketed column in order to form a cylindrical bed with a diameter of 2.5 cm and a height of 30 cm.

The material is then activated at room temperature T=20° C. with a solution of lithium chloride LiCl with a concentration of 0.02 mol/L in a downward flow at a flow rate of 3 BV/h. The total volume of solution of LiCl used is 14 BV.

Once the activation step is completed, loading is carried out by means of natural brine, the composition of which is given in Table 3.

TABLE 3
composition of the natural brine used for the loading

| | Na | K | Li | Mg | Ca | B | SO₄ | Sr | Cl |
|---|---|---|---|---|---|---|---|---|---|
| Concen- | 4.4 | 0.24 | 0.068 | 0.086 | 0.040 | 0.031 | 0.035 | 0.001 | 4.89 |
| tration | | | | | | | | | |
| (mol/L) | | | | | | | | | |

The loading of the activated material by adsorption is carried out by having the natural brine pass over said activated material, at a temperature of 60° C., the temperature being maintained by means of a circulation of heated water in the jacket, with an upper flow rate of 3 BV/h.

Under the conditions of the Example, the adsorption capacity of the material is 4.7 mg of Li/g of dry solid material for a lithium recovery yield of 93%.

At the end of the loading, the washing step is practiced by using an aqueous solution of sodium chloride. This solution is prepared with saturation of sodium chloride NaCl at 20° C. The solution is then heated to 60° C. and passed at the same temperature in a downward flow in the column at a rate of 3 BV/h for a total amount of 4 BV.

Next, it is proceeded with the step for desorption of lithium by having a lithium chloride (LiCl) with a concentration of 0.02 mol/L pass over said solution. This desorption is carried out at a temperature of 20° C. with a flow rate of 3 BV/h and with a downward flow. The eluate containing the lithium is recovered between 0.75 and 2.25 BV.

The composition of the eluate as well as the resulting decontamination factors are summarized in Table 4.

TABLE 4
composition of the eluate and decontamination factors

| X | Na | K | Li | Mg | Ca | B | SO₄ | Sr | Cl |
|---|---|---|---|---|---|---|---|---|---|
| Composition | 0.52 | 3.3 · 10⁻⁴ | 0.11 | 8.6 · 10⁻³ | 4.3 · 10⁻³ | 1.0 · 10⁻³ | 9.4 · 10⁻⁵ | 8.0 · 10⁻⁶ | 0.66 |
| (mol/L) | | | | | | | | | |
| Decontamination | 10 | 1000 | — | 15 | 10 | 50 | 500 | 90 | 10 |
| factor | | | | | | | | | |

The concentration of elements in the brine and in the eluate are determined by the optical ICP method known to one skilled in the art.

The Cl concentrations in the eluate and the brine are determined by the ion chromatography method known to one skilled in the art.

The extraction method according to the invention therefore allows selective extraction of the lithium from the natural brine. The selectivity with respect to lithium is expressed as a decontamination factor which is equal to the molar ratio X/Li in the initial natural brine divided by the molar ratio X/Li in the eluate and which takes into account the outer provision of lithium by the washing solution.

The obtained results indicate that the solid prepared according to the invention is particularly selected in potassium (K), in strontium (Sr) in boron (B) and in sulfates (SO₄).

### Example 8

### Non-Compliant

test of the materials not compliant with the invention achieved according to Examples 1 and 2 in a method for extracting lithium.

The solid material of formula LiCl.2Al(OH)₃,nH₂O prepared according to Example 1, according to a synthesis method not compliant with the invention in that the shaping step of the obtained slurry is achieved according to the conventional acid/basic kneading/extrusion technique and tested in a method for extracting lithium operating under conditions identical with those of Example 7.

As indicated in Example 1, no intact extrudate was able to be obtained. The obtained rings are very friables and do not have any hold in the brine.

The material prepared in Example 1 is introduced into a jacketed column identical with the one used in Example 7.

However, as soon as the activation step of the material, the appearance of powder is ascertained rapidly causing fouling of the column and impossibility of circulating the brine.

In the same way, the solid material of formula LiCl.2Al(OH)₃,nH₂O prepared according to Example 2, according to a synthesis method not compliant with the invention in that the step for shaping the obtained slurry is carried out by extrusion in the presence of an inorganic binder from the family of hydraulic binders added during the kneading phase and tested in a method for extracting lithium operating under conditions identical with those of Example 7.

As indicated in Example 2, the obtained extrudates are friable and have many cracks.

After its introduction into a jacketed column identical with the one used in Example 7, and as soon as the activation step of the material, the appearance of powder is ascertained rapidly causing fouling of the column and impossibility of circulating the brine.

The materials prepared according to a preparation method not compliant with the invention do not give the possibility of using them in a method for selectively extracting lithium because of their poor cohesion.

1. A method for preparing a crystallized solid material of formula LiCl.2Al(OH)₃,nH₂O with n being comprised between 0.01 and 10, said method comprising at least the following steps:
a) mixing, in an aqueous medium, at least one source of alumina and at least one source of lithium for obtaining a suspension,
b) filtering the suspension obtained in step a) for obtaining a slurry,
c) drying the slurry obtained at the end of step b), at a temperature comprised between 20 and 80° C. for a period comprised between 1 h and 12 h,
d) shaping by extrusion said dried slurry, directly after the drying step c) for obtaining extrudates, said shaping step d) being carried out in the absence of any binder,
e) drying extrudates at the end of step d) at a temperature comprised between 20 and 200° C. for a period comprised between 1 and 20 hours, for obtaining the crystallized solid material of formula LiCl.2Al(OH)₃,nH₂O as extrudates.

2. The method according to claim 1, wherein the alumina source is aluminium trihydroxide Al(OH)₃.

3. The method according to claim 1 or 2, wherein the lithium source(s) is(are) selected from among lithium chloride (LiCl), lithium hydroxide (LiOH), lithium nitrate (LiNO₃), lithium sulfate (Li₂SO₄), lithium carbonate (Li₂CO₃), and any mixture thereof.

4. The method according to claim 3, wherein the lithium source is lithium chloride (LiCl).

5. The method according to claim 1, wherein said mixing step a) operates at a temperature comprised between 40 and 120° C. for a period comprised between 1 hour and 10 hours.

6. The method according to claim 1, wherein said dried slurry does not undergo intermediate steps between said drying step c) and said shaping step d) by extrusion.

7. The method according to claim 1, wherein said drying step e) operates at a temperature comprised between 20 and 100° C. for a period comprised between 1 hour and 18 hours.

8. A solid material of formula LiCl.2Al(OH)₃,nH₂O with n being comprised between 0.01 and 10, shaped in the form (A an extrudate, and not comprising any binder.

9. A crystallized solid material of formula LiCl.2Al(OH)₃,nH₂O with n being comprised between 0.01 and 10, shaped in the form of extrudates, which may be obtained according to a method as defined according to claim 1.

10. A method for extracting lithium from saline solutions using solid materials of formula LiCl.2Al(OH)₃ nH₂O with n being comprised between 0.01 and 10, shaped in the form of extrudate, and not comprising any binder.

11. The extraction method according to claim 10, wherein said method for extracting lithium comprises at least the following steps:
activating said crystallized solid material of formula LiCl.2Al(OH)₃,nH₂O with n being comprised between 0.01 and 10,
loading said material activated by adsorption achieved by having said saline solution pass over said activated material,
washing the saline solution impregnating said material by having a washing solution pass over said material,
desorbing the lithium achieved by having water or an aqueous lithium salt solution pass over said material in order to obtain an eluate comprising at least some lithium.

12. The extraction method according to claim 11, wherein said activation is carried out by having water or a lithium chloride (LiCl) solution pass downwards or upwards with a concentration comprised between 0.001 mol/L and 0.1 mol/L.

13. The extraction method according to claim 11, wherein the activation is carried out at a temperature comprised between 0° C. and 90° C., and at a flow rate comprised between 0.1 BV/h and 30 BV/h, BV/h meaning the volume occupied by the bed of the solid in one column per hour.

14. The extraction method according to claim 11, wherein said loading is carried out at a temperature comprised between 0° C. and 90° C. and at a flow rate comprised between 0.1 BV/h and 30 BV/h, BV/h meaning the volume occupied by the bed of the solid in one column per hour.

15. The extraction method according to claim 11, wherein said washing solution used in the washing step is an aqueous sodium chloride (NaCl) solution optionally comprising lithium chloride (LiC1) or water.

16. The extraction method according to claim 11, wherein said washing is carried out at a temperature comprised between 0° C. and 90° C. and at a flow rate comprised between 0.1 BV/h and 30 BV/h, BV/h meaning the volume occupied by the bed of the solid in one column per hour.

17. The extraction method according to claim 11, wherein said desorbing is carried out by having water or a lithium chloride (LiCl) solution containing from 0.001 mol/L to 2 mol/L of LiCl pass upwards or downwards.

18. The extraction method according to claim 11, wherein said desorbing is carried out at a temperature comprised between 0° C. and 90° C. and at a flow rate comprised between 0.1 BV/h and 30 BV/h, BV/h meaning the volume occupied by the bed of the solid in one column per hour.

19. A device for extracting lithium wherein said device comprises a unit comprising at least one column, said column comprising at least one packing comprising crystallized solid materials of formula LiCl.2Al(OH)₃,nH₂O with n being comprised between 0.01 and 10, shaped in the form of extrudates, and not comprising any binder.

20. A device for extracting lithium wherein said device comprises a unit comprising at least one column, said column comprising at least one packing comprising crystallized solid materials of formula LiCl.2Al(OH)₃,nH₂O with n being comprised between 0.01 and 10, which may be obtained according to a method as defined according to claim 1.

21. A method for extracting lithium from saline solutions using crystallized solid materials of formula LiCl.2Al(OH)₃,nH₂O with n being comprised between 0.01 and 10, shaped in the form of extrudates, which may be obtained according to a method as defined according to claim 1.
